(19) United States
(12) Patent Application Publication
(10) Pub. No.: US 2026/0172619 A1
(43) Pub. Date: Jun. 18, 2026

(54) Use of Machine-Learning to Predict, Based on Ambient Light, When a Visual Media Presentation Device was Presenting Visual Media Content

(71) Applicant: The Nielsen Company (US), LLC, New York, NY (US)

(72) Inventors: Alexander Topchy, New Port Richey, FL (US); Vladimir Kuznetsov, New York, NY (US); Christen V. Nielsen, Tampa, FL (US); David Gish, Riverdale, NJ (US); Meryem Berrada, Beacon, NY (US); Wendell D. Lynch, East Lansing, MI (US); Justin Dan Mathew, Fort Lauderdale, FL (US); Sadhana Gupta, Columbia, MD (US)

(21) Appl. No.: 19/279,695

(22) Filed: Jul. 24, 2025

Related U.S. Application Data
(60) Provisional application No. 63/735,584, filed on Dec. 18, 2024.

(51) Int. Cl. H04N 21/41; H04N 21/466

(52) U.S. Cl. CPC H04N 21/4131; H04N 21/466

(57) ABSTRACT

A method and system for use of ambient light information as a basis to predict whether a visual media-presentation device such as a television was presenting visual media content. An example method includes use of one or more light sensors to monitor changes in ambient light over a period of time within a space encompassing the visual media-presentation device, and generating ambient-light data representing the monitored changes. Further, the example method includes providing the generated ambient-light data as input to a trained machine-learning model, and receiving from the trained machine-learning model, based on the provided ambient-light data, a prediction of whether the visual media-presentation device was presenting visual media content during the period of time. Further, the example method may then use the received prediction as a basis to take action, such as to control media-exposure measurement.

### REFERENCE TO RELATED APPLICATION

This application claims priority to U.S. Provisional Patent Application No. 63/735,584, filed Dec. 18, 2024, the entirety of which is hereby incorporated by reference.

### SUMMARY

In order to measure the extent to which people of various demographics are exposed to media content presented by media presentation devices such as televisions, a media-monitoring company can arrange to have media-monitoring devices or “meters” monitor media presentation in representative households or other sites. People who have their media exposure monitored may be considered “panelists,” and the places where the monitoring occurs, such as home, offices, or other premises, may be considered “panelist sites.” Panelists may opt-in to this monitoring.

At each of various panelist sites having a television, the media-monitoring company may arrange for a meter to monitor and detect media presentation by the television.

By way of example, a meter may be connected as an intermediary in an input feed to the television so that the meter can monitor media content that gets delivered to the television for presentation. Alternatively, the meter may be positioned near the television and may monitor media presentation by monitoring acoustic audio output from the television. Other arrangements are possible as well.

A representative meter, alone or through interworking with a back-end system, may monitor media presentation and thus panelist media exposure in various ways. For example, the meter may obtain digital signature data representing the presented media content and may report that digital signature data to the back-end system, and the back-end system may match the reported digital signature data with digital signature data representing known media content, to thereby determine that that known media content was being presented at the panelist site.

As a specific example, the meter may generate digital fingerprints representing component features of the media content presented and may send those query fingerprints to the back-end system, and the back-end system may match the query fingerprints with reference fingerprints representing known media content, in order to identify the media content (e.g., a specific program or ad, and/or a specific channel) presented. Alternatively, if the media content is watermarked with a content ID or otherwise contains or is accompanied by data that identifies the content, the meter may decode or otherwise read or ascertain that ID or other data from the media content and may report that information to the back-end system.

Further, in these or other examples, the back-end system may correlate this media-exposure data with demographics of the panelist or panelist site at issue, to help establish associated ratings statistics that may facilitate commercial processes such as ad placement and other content delivery.

One technical issue that may arise with such a media-exposure monitoring system is that it may be inefficient for the meter to regularly report digital signature data to the back-end system or to report digital signature data for all times. In practice, there may be times when the media-presentation device is not actually presenting media content, and times when the media-presentation device is presenting media content. Reporting digital signature data for times when the media-presentation device is not actually presenting media content would be inefficient both in terms of the reporting and in terms of processing by the meter and by the back-end system.

It would therefore be useful to limit the reporting to be for times when the media-presentation device was actually presenting media content. Alternatively, it may be useful for the meter to inform the back-end system when the media-presentation device was presenting media content, to help limit processing to be with respect to digital signature data as to those times. To facilitate these or other operations, it would be useful to provide a mechanism for the meter to determine when the media-presentation device is presenting media content versus when the media-presentation device is not presenting media content.

As presently contemplated, one way to achieve these and/or other related goals is to use machine-based processing of ambient-light information in the space where the media-presentation device is located.

In practice, there may be changes in ambient light within that space over time, due to factors such as flickering of room lighting (e.g., from LED bulb flickering and or from light interference by a periodically rotating ceiling fan or the like) and variation in light resulting the space through windows or from adjacent spaces. Further, when the media-presentation device is presenting visual content such as television programming, there may be changes in lighting in the space corresponding with changes in brightness of the visual content presentation over time, e.g., with program scenes changing over time.

The present disclosure provides for using machine-based analysis of ambient lighting in the space as a basis to distinguish between when the media-presentation device is presenting visual content and when the media-presentation device is not presenting visual media content. In particular, a computing system could use machine-based analysis to determine when changes in ambient light in the space over time are characteristic of visual content presentation by the media-presentation device, as compared with changes in ambient light in the space that are not characteristic of visual content presentation by the media-presentation device.

In one respect, for instance, disclosed is a method that includes (i) monitoring changes in ambient light over a period of time within a space encompassing a visual media presentation device such as a television, and generating ambient-light data representing the monitored changes, (ii) providing the generated ambient-light data as input to a trained machine-learning model, and (iii) receiving from the machine-learning model, based on the provided ambient-light data, a prediction of whether the visual media presentation device was presenting visual media content during the period of time. In addition, the method may then include using the received prediction as a basis to control media-exposure measurement and/or to take other action.

Further, in another respect, disclosed is a computing system that includes at least one ambient-light sensor, at least one processor, non-transitory data storage, and program instructions stored in the non-transitory data storage and executable by the at least one processor to carry out operations including (i) receiving, from the ambient-light sensor, signaling representing the ambient light sensed over time in a space encompassing a visual media-presentation device such as a television, (ii) based on the signaling, monitoring changes in the ambient light over the period of time, and generating ambient-light data representing the monitored changes, (iii) providing the generated ambient-light data as input to a trained machine-learning model, and (iv) receiving from the machine-learning model, based on the provided ambient-light data, a prediction of whether the visual media-presentation device was presenting visual media content during the period of time. In addition, the operations may include using the received prediction as a basis to control media-exposure measurement and/or to take other action.

Still further, in another respect, disclosed is at least one non-transitory computer-readable storage medium having stored thereon program instructions executable by at least one processor to carry out operations such as those noted above.

Yet further, in another respect, disclosed is a computer program product comprising a set of program instructions executable by at least one processor to carry out operations such as those noted above.

These and other aspects, advantages, and alternatives, will become apparent to those of ordinary skill in the art by reading the following detailed description, with reference where appropriate to the accompanying drawings. Further, it should be understood that the disclosure provided in this summary and elsewhere in this document is provided by way of example only and that numerous variations and other examples may be possible as well.

### BRIEF DESCRIPTION OF THE DRAWINGS

FIG. 1 is a simplified block diagram of an example space in connection with which disclosed features could be implemented.

FIG. 2 is a simplified block diagram depicting an example arrangement for carrying out disclosed features.

FIG. 3 is a flow chart illustrating an example method.

FIG. 4 is a simplified block diagram depicting an example computing system.

### DETAILED DESCRIPTION

In an example implementation, a meter will be equipped with (e.g., will include or be in communication with) at least one light sensor that operates to sense one or more characteristics of ambient light (e.g., intensity, color temperature, color, etc.) in a space in which a television is located. By use of the at least one sensor, the meter will be configured to sample at least one ambient-light characteristic in that space at a sampling rate that is deemed to be fast enough to facilitate the present process. Through this periodic or other sampling of the at least one ambient-light characteristic in the space, the meter will thus establish a sequence representing changes in the at least one ambient-light characteristic over time. For instance, the meter may sample the at least one ambient-light characteristic every second and determine, for each sample, one or more changes from the meter's immediately preceding sample of the at least one ambient-light characteristic, thus establishing a sequence of changes in the at least one ambient-light characteristic over time.

Further, the meter may apply a trained machine-learning model as a basis to evaluate this sequence of changes of the at least one ambient-light characteristic over time, possibly on a sliding window basis, among other possibilities. For instance, the meter may provide as input to the trained machine-learning model the most recent twenty-second (or other length) segment of the established sequence of changes in the at least one ambient-light characteristic over time, and the meter may receive as output from the trained machine-learning model, based on the provided input, a prediction of whether or not, for that twenty-second segment, the television was presenting visual content.

To facilitate this, the machine-learning model may be trained with example data that helps the machine-learning model learn whether a given sequence of changes in the at least one ambient-light characteristic over time is likely to represent presentation of visual content by the television as compared with changes in the at least one ambient-light characteristic that are more likely due to other sources such as flickering bulbs or changes in outside light entering through a window for instance.

By way of example, a computing system could obtain a set of labeled training data, which may comprise many (e.g., potentially thousands) of similar-length (e.g., twenty-second length) segments of changes in ambient-light intensity in given space each labeled to indicate whether or not a television in the given space was presenting visual content at the time. This training data may relate to the specific space at issue in the panelist site in the example above, and/or may stem from analysis in many different panelist sites, labs, or other spaces. The computing system could feed each instance of this labeled training data into a machine-learning model, have the model predict based on the instance of training data a likelihood that the television was presenting visual content at the time corresponding with the input, and use backpropagation to revise the model's weights and biases, repeating this process for the many instances of labeled input. Ultimately, this may train the machine-learning model to predict with a desired level of certainty whether, given a test input segment for a given period of time, the television was presenting visual content in that period of time.

Alternatively, the machine-learning model could be trained through unsupervised learning, to distinguish based on the changes in ambient light over time whether and when a television is presenting visual content.

Once the machine-learning model is so trained, the trained model could be stored in the meter for use by the meter as noted above to determine over time when the television is presenting visual media content and when the television is not presenting visual media content. The meter may then use this determination over time as a basis to control when the meter will obtain signature data for reporting to the back-end system and/or for what time periods the meter should report signature data to the back-end system. Alternatively or additionally, the meter may include this determination along with time-corresponding signature data, in its reporting to the back-end system, and the back-end system may use this determination per instance of signature data to control whether or not to process the reported signature data as a basis for measuring media exposure.

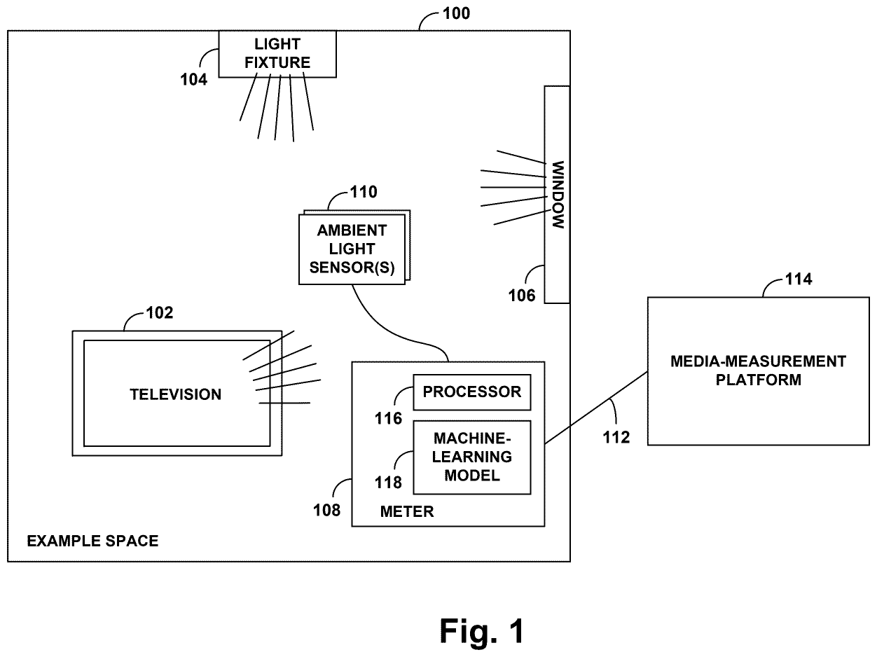

FIG. 1 illustrates an example space 100 in connection with which this process could operate. This space 100 may be a room or other open space within a building or may be located elsewhere, such as within a vehicle or possibly outdoors, among other examples.

As shown in FIG. 1, the example space 100 includes a television 102, which may at times present visual media content (e.g., video content) and at other times not present visual media content. Further, the example space includes some example sources of ambient light, such as a ceiling light fixture 104 that may cast light generally in the space 100, and a window 106 through which external light may enter the space 100.

In addition, the example space 100 is shown including a meter 108 equipped with at least one ambient-light sensor 110. In practice, the meter 108 may be physically present in the space 100 to facilitate carrying out various metering operations there and may include or be in communication with the at least one ambient-light sensor 110 also in the space 100 to facilitate receiving information about ambient light within the space 100. Alternatively, the meter 108 may be located elsewhere and may be in communication with the at least one ambient-light sensor 110 physically present in the space 100 to facilitate receiving information about ambient light within the space 100.

In the example arrangement, the meter 108 is shown having a communication path 112 to a back-end media-measurement platform 114, through which the meter 108 may report metering data such as extracted or determined audio signatures for instance, to enable the media-measurement platform 114 to engage in media-exposure measurement and/or other associated action. The communication path 112 could take various forms, possibly including a local area network (LAN) connection and/or a cellular-wireless connection, among other possibilities.

Further, the example meter 108 is shown including a processor 116 and a trained machine-learning model 118. The processor 116 may be configured (e.g., programmed) to carry out various meter operations, which may include establishing and reporting audio signature data as noted above, and may also include executing the trained machine-learning model 118.

In the example implementation, the trained machine-learning model 118 is executable by the processor 116 to predict, based on evaluation of sensed ambient light in the space 100, whether or not the television 102 in the space 100 was presenting visual media content at the time the ambient light was sensed. In line with the discussion above, the processor 116 of the meter 108 may use this prediction as a basis to control media-exposure measurement, such as to control what metering data the meter 108 reports to the media-measurement platform 114 and/or, by providing the prediction to the media measurement platform 114 along with (or in time-correlation with) associated metering data for instance, to facilitate control over the platform's generation of media-exposure data.

The at least one ambient-light sensor 110 may comprise one or more analog and/or digital ambient light sensors, such as one or more photodiodes, phototransistors, photonic integrated circuits, light dependent resistors (LDRs), and color or full-color ambient-light sensors, among other possibilities.

The at least one ambient-light sensor 110 is configured to detect and measure one or more characteristics of the general lighting conditions in its surrounding environment, as compared with sensing light directly from a specific light source. Thus, the at least one ambient-light sensor 110 may operate to sense the collective illumination in the space 100 rather than sensing light directly from a specific light source such as the television 102, the ceiling light fixture 104, or the window 106. (In practice, this may mean that the at least one sensor is not focused on a specific such light source, even if the general lighting in the space 100 results from that light source alone or in combination with other light sources.)

The at least one ambient-light sensor 110 may respond to the collective illumination present in the space 100 by converting that ambient light into a corresponding electrical signal that represents the one or more characteristics of the ambient light. For instance, the at least one ambient-light sensor 110 may respond to the ambient light in the space 100 by providing a signal in real-time that represents at least the level of intensity (e.g., in units of lux) of the ambient light, the color temperature (e.g., in kelvins) of the ambient light, and/or the color (e.g., wavelength or spectral composition) of the ambient light.

This signal may be a continuous signal that changes over time to represent corresponding change in an ambient-light characteristic. For instance, the magnitude or energy level of the signal over time may be proportional to the intensity, color temperature, or wavelength of the ambient light. Alternatively, the signal may be a discrete signal, with values of an ambient-light characteristic sampled at a sampling rate over time, among other possibilities.

In practice, the at least one ambient-light sensor 110 may regularly engage in this sensing, and the processor 116 of the meter 108 may thus regularly receive from the at least one ambient-light sensor 110 the signal representing the at least one sensed characteristic of the ambient light in the space 100. As the processor 116 receives this signal, the processor 116 may process the signal to establish a time series of ambient-light data points representing changes in at least one ambient light characteristic, such as changes in intensity, color temperature, or color over time. The data points in this time series can inherently represent changes in the at least one ambient-light characteristic by each data point indicating a respective ambient-light-characteristic value that may be the same as or different than the preceding data point, and/or by each data point indicating a delta between its sample ambient-light-characteristic value and the ambient-light-characteristic value of the preceding data point's sample

To establish this time series of ambient-light data points, the processor 116 may periodically sample the signal, establishing for each sample a respective data record that indicates (i) a timestamp or sequence number of the sample, (ii) ambient-light characteristic level, and (iii) a change in the ambient-light characteristic compared with the preceding sample. The processor 116 may perform this sampling at a sampling rate that will work well to facilitate evaluation of whether the television 102 was presenting visual media content at the time. For instance, the processor 116 could apply a sampling rate that is at least twice the frame rate of the television. By way of example, if the television has a 60 Hertz (Hz) frame rate, then the processor 116 may operate to sample the ambient-light information at a sampling rate of at least 120 Hz. Alternatively, the processor 116 could apply a lower sampling rate.

As the processor 116 generates this time series of ambient-light data points, the processor 116 may segment the time series into time windows of ambient light data points, to facilitate machine-learning analysis on a per-time-window basis. For example, the processor may segment the time series into overlapping time windows of ambient-light data points that are each 20 seconds long (encompassing 20 seconds of samples) and with a step size of 5 seconds, among other possibilities.

The processor 116 may then provide each time window of ambient-light data points respectively as input to the machine-learning model 118 and, for each time window of ambient-light data points, may execute the machine-learning model 118 to establish a respective prediction of whether the television 102 was presenting visual media content in that window of time (or more generally whether the ambient light in that time window included light from visual media content presentation by a television).

For each time window of ambient-light data points (e.g., for each step in a sliding-window analysis), the processor 116 may then use the established prediction as a basis to take action, such as to control media-exposure measurement. By way of example, if the processor 116 establishes (e.g., extracts or generates) audio signature based on audio in the environment, the processor 116 may determine respectively for each associated time window whether to report the audio signature data to the media-measurement platform 114.

For instance, if the prediction for a time window is that the television 102 was presenting visual media content in that time window, then, based at least in part on that prediction, the processor 116 may report the audio signature data of that time window to the media-measurement platform 114, to enable the media-measurement platform 114 to establish media-measurement data based on the audio signature data of that time window. Whereas, if the prediction for a time window is that the television 102 was not presenting visual media content in that time window, then, based at least in part on that prediction, the processor 116 may forgo reporting the audio signature data of that time window to the media-measurement platform 114, to help avoid having the media-measurement platform 114 seek to establish media-measurement data based on the audio signature data of that time window.

Alternatively, when reporting audio signature data of a given time window to the media-measurement platform 114, the processor 116 may also report to the media-measurement platform 114 the prediction for that time window, as a way to help control media-exposure measurement. In this case, the reporting of the prediction may enable the media-measurement platform to control whether or not it will generate media-exposure data based on the audio signature data. Namely, if the prediction is that the television 102 was presenting visual media content in that time window, then, based at least in part on that prediction, the media-measurement platform 114 may generate media-exposure data based on the audio signature data of that time window. Whereas, if the prediction is that the television 102 was not presenting visual media content in that time window, then, based at least in part on that prediction, the media-measurement platform 114 may forgo generating media-exposure data based on the audio signature data of that time window.

The trained machine-learning model 118 used in this process could be a binary or multi-class machine-learning model that is trained to make a prediction, based on changes in ambient-light data in a given space throughout a given time window, of whether a television was presenting visual media content in that space during that time window, and to output that prediction possibly together with a level of its confidence int hat prediction. In an example implementation, the prediction can be whether the changes in one or more ambient-light characteristics in the time window at issue resulted at least in part from changes in light emitted by a television presenting visual media content in that time window, rather than resulting from merely one or more other factors such as operation of light fixtures, changes in natural light shining through windows, movement of objects in the space, for instance.

As noted above, the process of training the model 118 to make this prediction could involve supervised or unsupervised learning, in either case taking into account a set of training data that is of a sufficient size and quality to result in the model being able to make the prediction with a desired threshold level of confidence. The training data could be based on changes in ambient-light conditions over time specifically in the space 100 at issue and/or could be based on changes in ambient-light conditions over time in each of one or more spaces possibly but not necessarily including space 100.

For a supervised learning process, this training data could be established like the input data noted above and could further be supplemented, per time window, with a label denoting whether or not a television was presenting visual media content in the associated space during that time window. For instance, for each of one or more spaces, a television in the space could be set to turn on and off at potentially random times throughout one or more days, and associated data could thus indicate per space, times when the television in the space was on and presenting visual media content and times when the television in the space was off and thus not presenting visual media content. A computing system could then map this time data to timestamped ambient-light data such as that noted above in order to programmatically produce a label per ambient-light data point of whether or not the television was presenting visual media content at the associated time.

On a per-time window basis, the computing system could provide this labeled training data as input to the machine-learning model 118, the machine-learning model could output a prediction of whether a television in the associated space was presenting visual media content during that time window, the computing system could compare that output prediction with the label of whether or not a television in the space was in fact presenting visual media content during the time window, and the computing system could adjust weights and biases in the model based on that comparison (e.g., making adjustments designed to help improve confidence in a next prediction by the model).

For an unsupervised learning process, the training data could likewise be established like the input data noted above and, on a per-time window basis, the computing system could provide that the training data as input to the machine-learning model 118. But there may be no labeling of the data. Rather, in executing the machine-learning model 118 in this training phase, a computing system may evaluate many time windows of input data in order to find anomalies that may represent situations where a television was presenting visual media content.

For instance, the machine-learning model 118 may cluster the data, looking for patterns in the input data versus anomalies from those patterns. In practice, for example, the model 118 may discover patterns such as periodic changes in ambient-light intensity that may result from flickering of LED room lights, and/or periodic changes in ambient-light intensity that may result from changes in level of sunlight through a window based on times of day. Whereas, the model 118 may further discover as anomalies some changes in ambient-light intensity that are not repetitive like that and therefore that do not fit into those recognized patterns or clusters. Example visual media content presentation by a television may include such aperiodic changes in ambient-light conditions over time. Thus, through this analysis, the model 118 may become trained to predict whether or not a time window of ambient-light data represents emanating at least in part from a television presenting visual media content in that time window.

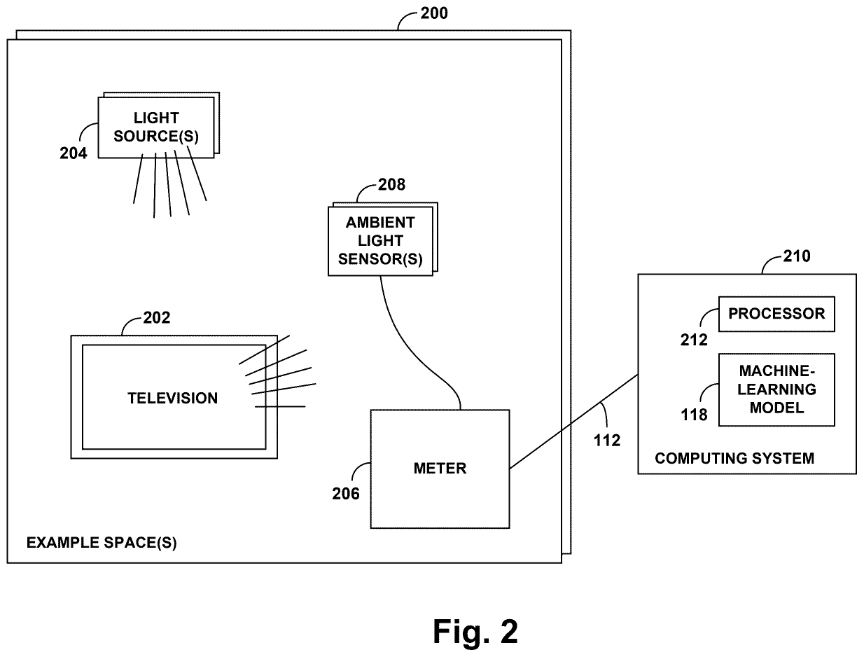

FIG. 2 is next a simplified block diagram depicting an example arrangement for carrying out this or other training of the machine-learning model 118. In FIG. 2, the example arrangement includes one or more spaces 200, one of which may be space 100. Each space 200 is shown including a television 202 and one or more light sources 204 (e.g., light fixtures, windows, etc.) Further, each space 200 is shown including a meter 206 with one or more ambient-light sensors 208. The meter 206 of each space 200 may then be coupled with a cloud-based computing system 210 that includes a processor 212 and the machine-learning model 118.

With this arrangement, the one or more ambient-light sensors 208 in each space 200 could sense and provide the meter 206 in the space with ambient-light information at both times when the television 202 in the space is presenting visual media content and times when the television 202 in the space is not presenting visual media content. Based on this ambient-light information, the meter 206 in each space may then generate and provide to the computing system 210 a time series of ambient-light data like that noted above or may provide to the computing system 210 the raw ambient-light information and the computing system 210 may generate the time series of ambient-light data based on that information.

On a per-time-window basis, the computing system 210 may then provide the ambient-light data as input to the machine-learning model 118, to facilitate training the machine-learning model 118 through supervised or unsupervised learning as noted above.

Once the machine-learning model 118 is so trained, the trained machine-learning model (e.g., defined by its weights, biases, and architecture), could then be deployed on meter 108 in space 100, to enable the meter 108 to predict for any given time window whether television 102 was presenting visual media content in the space 100. Alternatively, the trained model 118 could be hosted in the cloud, and meter 108 could be configured to signal to a cloud-based server or the like to get or facilitate determining the prediction on a per time window basis.

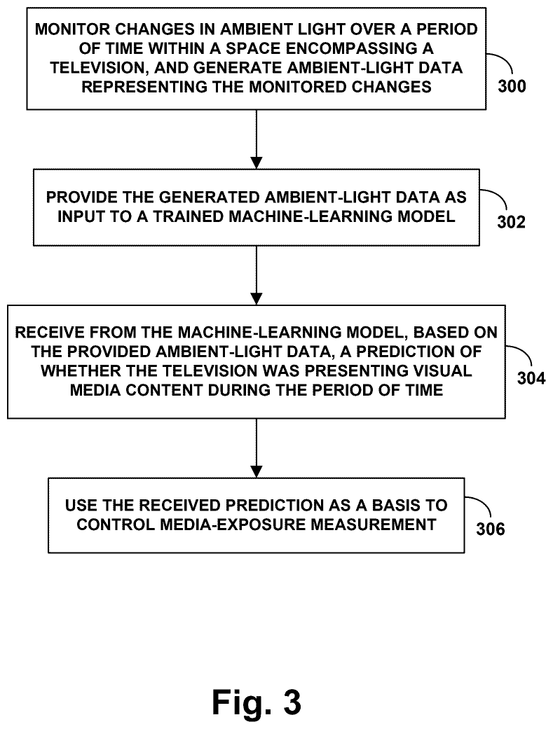

FIG. 3 is a flow chart illustrating an example method that could be carried out in accordance with the present disclosure. This method could be carried out, for instance, by the meter 108 and/or by one or more other computing systems.

As shown in FIG. 3, at block 300, the method includes monitoring changes in ambient light over a period of time within a space encompassing a television, and generating ambient-light data representing the monitored changes. At block 302, the method includes providing the generated ambient-light data as input to a trained machine-learning model. At block 304, the method then includes receiving from the machine-learning model, based on the provided ambient-light data, a prediction of whether the television was presenting visual media content during the period of time. And at block 306, the method includes using the received prediction as a basis to control media-exposure measurement.

In line with the discussion above, in this example method, the act of using the received prediction as a basis to control media-exposure measurement could involve using the received prediction as a basis to control reporting of media-exposure data to a media-measurement platform. Alternatively or additionally, the act of using the received prediction as a basis to control media-exposure measurement could involve using the received prediction as a basis to control generating of media-exposure data, such as by providing the data to facilitate this control.

As further discussed above, the act of monitoring the changes in ambient light over the period of time could involve sampling the ambient light, possibly at a sampling rate that is at least two times a frame rate of the television. In addition, the act of generating the ambient-light data based on the monitoring could involve, for each sample of the ambient light, generating at least one corresponding data value indicating at least one change in the ambient light from an immediately preceding sample of the ambient light. For instance, the at least one data value may indicate a change in intensity of the ambient light, perhaps a whether the intensity has increased, decreased, or was unchanged, and possibly indicating a delta in intensity of the ambient light. Alternatively, the at least one data value may indicate a change in color temperature of the ambient light and/or a change in color of the ambient light.

Still further, as discussed above, the method could involve repeating the operations of the method on a sliding window basis. For instance, the method could involve, on a per-sliding-window basis, carrying out the operations of blocks 300, 302, 304, and 306. Moreover, the method could be carried out by a computing system that is within the space and/or by an external computing system.

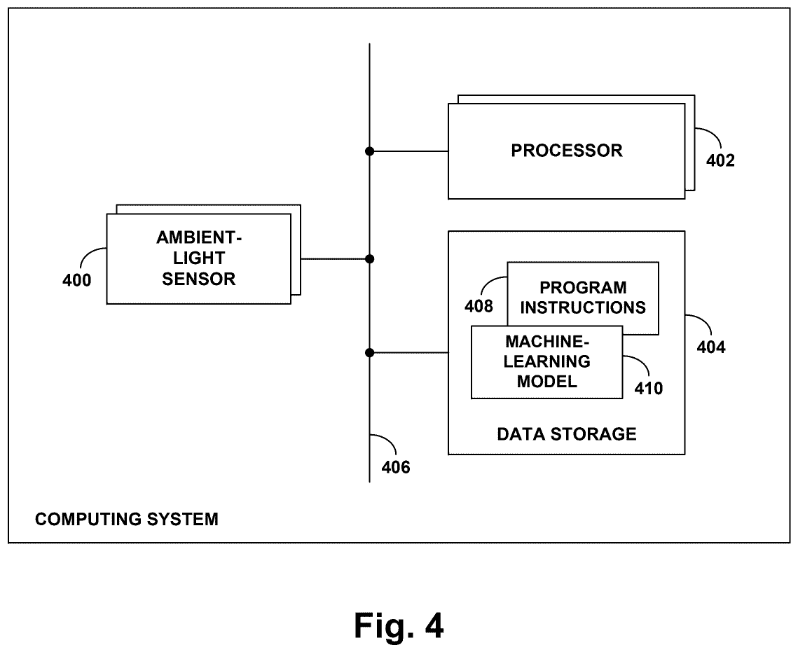

FIG. 4 is a simplified block diagram of an example computing system, which may represent a meter such as meter 108 and/or one or more other computing platforms that may be positioned in the space at issue or elsewhere. As shown in FIG. 4, the example computing system includes at least one ambient-light sensor 400, at least one processor 402, and non-transitory data storage 404, any or all of which may be integrated together and/or interconnected by a system bus, network, or other connection mechanism 406, among other possibilities.

The at least one ambient-light sensor 400 may take any of the forms noted above. The at least one processor 402 may comprise one or more general purpose processors (e.g., microprocessors) and/or one or more specialized processors (e.g., digital signal processors (DSPs), graphics processing units (GPUs), neural processing units (NPUs), etc.) And the non-transitory data storage 404 may include one or more volatile and/or non-volatile storage components (e.g., flash, optical, magnetic, read only memory (ROM), random access memory (RAM) (e.g., dynamic RAM (DRAM), static RAM (SRAM), or double data rate RAM (DDRAM)), electronically programmable read only memory (EPROM), and/or electronically erasable programmable read only memory (EEPROM), etc.), which may be integrated in whole or in part with the processor 403 or may be provided separately.

As further shown, the non-transitory data storage 404 may store (e.g., hold or embody) program instructions 408. These program instructions 408 may be executable by the at least one processor 402 to cause the computing system to carry out various operations as described herein. Further, the non-transitory data storage 404 is shown including a machine-learning model 410, possibly as part of the program instructions 408, which may be executable by the at least one processor 402 to generate predictions as noted above.

Use of machine-learning as described herein provides a technically useful mechanism to predict when a television or other such media-presentation device is actually presenting visual media content. Namely, a machine-learning model like that discussed above could work to distinguish between (i) changes in ambient-light intensity over time resulting from changes in brightness of presented visual media content and (ii) changes in ambient-light intensity over time resulting from other factors such as those noted above.

In addition, note that the one or more characteristics of ambient-light in a given space may also help to facilitate determining which of multiple televisions is presenting visual content, and/or which of multiple rooms or other spaces in a panelist site is where a television was presenting the visual content, which might be useful information for the back-office media-measurement platform to factor into its generation of media-exposure data or the like.

Different rooms or other spaces in a panelist site may have different lighting, based on differences in light sources in the spaces (e.g., different windows or ceiling lighting), and possibly based on differences in ambient-light emitted by the televisions of the respective spaces. Through machine-learning, a meter may therefore determine based on ambient lighting which television was presenting visual content in the panelist site and/or which room in the site was where a television was presenting the visual content and may report this information to the back-end system along with signature data to facilitate identification of the presented media content.

Here, for instance, the meter may use ambient-light data from one or more ambient-light light sensors in a space to detect the level of one or more ambient-light characteristics in the space over time and may generate a time series of that ambient-light data as noted above. On a sliding window basis, the meter may then provide segments of this sequence as input to a trained machine-learning model and may receive as output from the trained machine-learning model a prediction of which television was presenting visual content contributing to the ambient light and/or in which room or other space that presentation occurred.

To facilitate this, the machine-learning model could be trained based on example data indicating levels of the one or more ambient-light characteristics over time respectively in each of various rooms of the panelist site when televisions in the rooms were presenting visual content and when televisions in the rooms were not presenting visual content. For instance, the machine-learning model could be trained based on labeled data indicating a room identifier in correlation with levels of ambient-light intensity, color-temperature, and/or color over time, and (for supervised training) in correlation with indications of whether a television in the space was presenting visual media content at the time. Once trained, the machine-learning model could then predict, based on levels of the one or more ambient-light characteristics where a television was presenting visual content, such as in which room the television was located. Assuming televisions are correlated with specific rooms, this may then also facilitate a determination of which television was presenting the visual content.

An audience-measurement company could usefully include this information with media-exposure data, to facilitate various actions. By way of example, knowing which television a panelist was watching may facilitate triggering panelist-specific dynamic ad insertion on that television in particular. Other examples may be possible as well.

Note also that the presently disclosed principles could apply as well with respect to a visual media-presentation device other than a television, such as for instance a computer monitor, among other possibilities. Further, while the present disclosure describes determining whether a visual media-presentation device was presenting visual media content, it will be understood that this determination could be made through post-processing, or this determination could be made respect to a time period that just occurred and may therefore effectively be a real-time present tense determination.

Exemplary embodiments have been described above. Those skilled in the art will understand, however, that changes and modifications may be made to these embodiments without departing from the true scope and spirit of the invention.

What is claimed is:

1. A method comprising:
monitoring changes in ambient light over a period of time within a space encompassing a visual media-presentation device, and generating ambient-light data representing the monitored changes;
providing the generated ambient-light data as input to a trained machine-learning model;
receiving from the machine-learning model, based on the provided ambient-light data, a prediction of whether the visual media-presentation device was presenting visual media content during the period of time; and
using the received prediction as a basis to control media-exposure measurement.

2. The method of claim 1, wherein the visual media-presentation device is a television.

3. The method of claim 2, wherein using the received prediction as a basis to control media-exposure measurement comprises using the received prediction as a basis to control reporting of media-exposure data to a media-measurement platform and/or as a basis to control generating of media-exposure data.

4. The method of claim 2, wherein monitoring the changes in ambient light over the period of time comprises sampling the ambient light at a sampling rate that is at least two times a frame rate of the television.

5. The method of claim 4, wherein monitoring the changes in ambient light over the period of time comprises sampling the ambient light, and wherein generating the ambient-light data based on the monitoring comprises, for each sample of the ambient light, generating at least one corresponding data value indicating at least one change in the ambient light from an immediately preceding sample of the ambient light.

6. The method of claim 5, wherein the at least one data value indicates a change in intensity of the ambient light.

7. The method of claim 6, wherein the at least one data value indicates whether the intensity of the ambient light increased, decreased, or was unchanged.

8. The method of claim 6, wherein the at least one data value indicates a delta in intensity of the ambient light.

9. The method of claim 5, wherein the at least one data value indicates a change in color temperature of the ambient light.

10. The method of claim 5, wherein the at least one data value indicates a change in color of the ambient light.

11. The method of claim 2, further comprising repeating, on a sliding time window basis, the monitoring, providing, receiving, and using.

12. The method of claim 2, wherein the method is carried out by a computing system within the space.

13. A computing system comprising:
at least one ambient-light sensor;
at least one processor;
non-transitory data storage; and
program instructions stored in the non-transitory data storage and executable by the at least one processor to carry out operations including:
receiving, from the ambient-light sensor, signaling representing the ambient light sensed over time in a space encompassing a visual media-presentation device,
based on the signaling, monitoring changes in the ambient light over the period of time, and generating ambient-light data representing the monitored changes,
providing the generated ambient-light data as input to a trained machine-learning model,
receiving from the machine-learning model, based on the provided ambient-light data, a prediction of whether the visual media-presentation device was presenting visual media content during the period of time, and
using the received prediction as a basis to control media-exposure measurement.

14. The computing system of claim 13, wherein the visual media-presentation device is a television.

15. The computing system of claim 14, wherein using the received prediction as a basis to control media-exposure measurement comprises using the received prediction as a basis to control reporting of media-exposure data to a media-measurement platform and/or as a basis to control generating of media-exposure data.

16. The computing system of claim 14, wherein monitoring the changes in ambient light over the period of time comprises sampling the ambient light at a sampling rate that is at least two times a frame rate of the television.

17. The computing system of claim 16, wherein monitoring the changes in ambient light over the period of time comprises sampling the ambient light, wherein generating the ambient-light data based on the monitoring comprises, for each sample of the ambient light, generating at least one corresponding data value indicating at least one change in the ambient light from an immediately preceding sample of the ambient light, and wherein the at least one change in the ambient light comprises at least one of a change in intensity, a change in color temperature, and a change in color.

18. At least one non-transitory computer-readable storage medium having stored thereon program instructions executable by at least one processor to carry out operations including:
monitoring changes in ambient light over a period of time within a space encompassing a visual media-presentation device, and generating ambient-light data representing the monitored changes;
providing the generated ambient-light data as input to a trained machine-learning model;
receiving from the machine-learning model, based on the provided ambient-light data, a prediction of whether the visual media-presentation device was presenting visual media content during the period of time; and
using the received prediction as a basis to control media-exposure measurement.

19. The at least one non-transitory computer-readable storage medium of claim 18, wherein the visual media-presentation device is a television, and wherein monitoring the changes in ambient light over the period of time comprises sampling the ambient light at a sampling rate that is at least two times a frame rate of the television.

20. The at least one non-transitory computer-readable storage medium of claim 19, wherein monitoring the changes in ambient light over the period of time comprises sampling the ambient light, wherein generating the ambient-light data based on the monitoring comprises, for each sample of the ambient light, generating at least one corresponding data value indicating at least one change in the ambient light from an immediately preceding sample of the ambient light, and wherein the at least one change in the ambient light comprises at least one of a change in intensity, a change in color temperature, and a change in color.
